(19) United States
(12) Patent Application Publication
(10) Pub. No.: US 2026/0093458 A1
(43) Pub. Date: Apr. 2, 2026

(54) MANAGING AN APP INCLUDING AN APP MODEL AND INVOLVING A SIMPLIFIED APP MODEL METHOD AND SYSTEM

(71) Applicant: Mendix Technology B.V., Rotterdam (NL)

(72) Inventor: Sean Ryan, Den Haag (NL)

(21) Appl. No.: 18/901,835

(22) Filed: Sep. 30, 2024

(51) Int. Cl. G06F 8/20; G06F 11/36

(52) U.S. Cl. CPC G06F 8/20; G06F 11/3684

(57) ABSTRACT

A method includes providing an app management UI of an app management platform to a user for developing an app, providing an app model, and determining a simplified app model. The simplified app model includes a respective first table linking the respective entity with respective entity attribute of the respective entity, and a second table linking the respective entity with the respective, associated entity. Natural language user input is received via the app management UI. A respective third table linking two entities, two entity attributes, or one entity and one entity attribute included by the respective subset, respectively, are determined using the user input, the respective first table, and the second table. Processed data associated with the respective subset is determined using the processing type, the respective third table, and a large language model, and the processed data is displayed.

### TECHNICAL FIELD

The present disclosure is directed, in general, to software management systems, in particular systems for developing apps, that may be used to manage, build, test, deploy and iterate such apps (collectively referred to here-in as product systems).

### BACKGROUND

The present embodiments generally relate to the development and the management of such apps, such as managing an app including an app model and involving a simplified app model.

Recently, an increasing number of computer software products is used both for personal needs and for business needs in the form of applications, throughout the present patent document simply called “apps”. Such apps may be used in a mobile context as well as on cloud computing platforms and “on premise” and may provide a specific set of functions.

Currently, there exist product systems and solutions which support managing or developing such apps. Such product systems may benefit from improvements.

### SUMMARY

Variously disclosed embodiments include methods and computer systems that may be used to facilitate managing an app, such as managing an app including an app model and involving a simplified app model.

According to a first aspect of the present embodiments, a computer-implemented method for managing an app, wherein the app model includes a plurality of entities which are associated with each other, and wherein the respective entity includes at least one respective entity attribute, may include: providing an app management UI of an app management platform to a user for managing the app; providing the app model; determining a simplified app model including a respective first table linking the respective entity with respective entity attribute of the respective entity, and a second table linking the respective entity with the respective, associated entity; receiving natural language user input via the app management UI, wherein the user input is indicative of a query for processing at least one subset of the app model according to a respective processing type, wherein the respective subset includes only some of the entities and some of the entity attributes; determining a respective third table linking two entities, two entity attributes, or one entity and one entity attribute included by the respective subset, respectively, using the user input, the respective first table relating to the entities and the entity attributes of the respective subset, and the second table, and optionally a large language model; determining processed data associated with the respective subset using the processing type, the respective third table, and the large language model; and displaying the processed data.

According to a second aspect of the present embodiments, a computer system may be arranged and configured to execute the steps of this computer-implemented method according to the first aspect.

According to a third aspect, a computer program product may include computer program code that, when executed by the computer system according to the second aspect, causes the computer system to carry out the method according to the first aspect.

According to a fourth aspect, a computer-readable medium may include the computer program product according to the third aspect. By way of example, the described computer-readable medium may be non-transitory and may further be a software component on a storage device.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the detailed description below, it should be understood that various definitions for certain words and phrases are provided throughout this patent document and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

Embodiments will be described below in greater detail.

### BRIEF DESCRIPTION OF THE DRAWINGS

FIG. 1 depicts a functional block diagram of an example system that facilitates managing an app, such as managing an app including an app model and involving a simplified app model, in a product system.

FIGS. 2-5 depict different aspects of various example methodologies that facilitate managing an app, managing an app including an app model and involving a simplified app model in a product system, respectively.

FIGS. 6-7 depict a flow diagram of example methodologies that facilitate managing an app, managing an app including an app model and involving a simplified app model in a product system, respectively.

FIGS. 8-10 depict a functional block diagram of further example systems that facilitate managing an app, such as managing an app including an app model and involving a simplified app model, in a product system, respectively.

FIG. 11 depicts a flow diagram of another example methodology that facilitates managing an app, such as managing an app including an app model and involving a simplified app model, in a product system.

FIG. 12 depicts a block diagram of a data processing system in which an embodiment can be implemented.

### DETAILED DESCRIPTION

Various technologies that pertain to systems and methods for managing an app, such as managing an app including an app model and involving a simplified app model, in a product system will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present patent document will be described with reference to exemplary non-limiting embodiments.

An app generally refers to a software program which on execution performs specific desired tasks. In general, several apps are executed in a runtime environment containing one or more operating systems (“OSs”), virtual machines (e.g., supporting Java™ programming language), device drivers, etc.

Apps, including native apps, can be created, edited, and represented using traditional source code. Examples of such traditional source code include C, C++, Java, Flash, Python, Perl, and other script-based methods of representing an app. Developing, creating and managing such script-based apps, or parts of such script-based apps can be accomplished by manual coding of suitably trained users.

Developers often use Application Development Frameworks (“ADFs”) (which are by themselves applications or apps) for implementing/developing desired apps. An ADF provides a set of pre-defined code/data modules that can be directly/indirectly used in the development of an app. An ADF may also provide tools such as an Integrated Development Environment (“IDE”), code generators, debuggers, etc., which facilitate a developer in coding/implementing the desired logic of the app in a faster/simpler manner.

In general, an ADF simplifies app development by providing reusable components which can be used by app developers to define user interfaces (“UIs”) and app logic by, for example, selecting components to perform desired tasks and defining the appearance, behavior, and interactions of the selected components. Some ADFs are based on a model-view-controller design pattern that promotes loose coupling and easier app development and maintenance.

According to another approach, apps can also be created, edited, and represented using visual model-based representations. Unlike traditional source code implementations, such apps can be created, edited, and/or represented by drawing, moving, connecting, and/or disconnecting visual depictions of logical elements within a visual modeling environment. Visual model-based representations of apps can use symbols, shapes, lines, colors, shades, animations, and/or other visual elements to represent logic, data or memory structures or user interface elements. In order to program a traditional script-based app, programmers are typically required to type out detailed scripts according to a complicated set of programming syntax rules. In contrast, programming a visual model-based app can, in some cases, be done by connecting various logical elements (e.g., action blocks and/or decision blocks) to create a visual flow chart that defines the app's operation. Similarly, defining data structures (e.g., variable types, database objects, or classes) and/or user interface elements (e.g., dropdown boxes, lists, text input boxes) in a visual model-based app can be done by drawing, placing, or connecting visual depictions of logical elements within a virtual workspace, as opposed to typing out detailed commands in a script. Visual-model based apps, including native apps, can therefore be more intuitive to program and/or edit compared to traditional script-based apps. In the present document, an approach is suggested to manage apps, such as creating an app including an app model, which may involve the explained visual model-based representations.

For brevity, references to a “model,” a “visual model,” or an “application” or “app” should be understood to refer to visual model-based apps, including native apps, unless specifically indicated. In some cases, such visual model-based apps can represent complete, stand-alone apps for execution on a computer system. Visual model-based apps can also represent discrete modules that are configured to perform certain tasks or functions, but which do not represent complete apps—instead, such discrete modules can be inserted into a larger app or combined with other discrete modules to perform more complicated tasks. Examples of such discrete modules can include modules for validating a ZIP code, for receiving information regarding current weather from a weather feed, and/or for rendering graphics.

Visual models may be represented in two forms: an internal representation and one or more associated visual representations. The internal representation may be a file encoded according to a file format used by a modeling environment to capture and define the operation of an app (or part of an app). For example, the internal representation may define what inputs an app can receive, what outputs an app can provide, the algorithms and operations by which the app can arrive at results, what data the app can display, what data the app can store, etc. The internal representation may also be used to instruct an execution environment how to execute the logic of the app during run-time. Internal representations may be stored in the form of non-human-readable code (e.g., binary code). Internal representations may also be stored according to a binary stored JSON (java script object notation) format, and/or an XML format. At run-time, an execution engine may use an internal representation to compile and/or generate executable machine code that, when executed by a processor, causes the processor to implement the functionality of the model.

The internal representation may be associated with one or more visual representations. Visual representations may include visual elements that depict how an app's logic flows, but which are not designed to be compiled or executed. These visual representations may include, for example, flow-charts or decision trees that show a user how the app will operate. The visual models may also visually depict data that is to be received from the user, data that is to be stored, and data that is to be displayed to the user. These visual models may also be interactive, which allows a user to manipulate the model in an intuitive way. For example, visual representations may be configured to display a certain level of detail (e.g., number of branches, number of displayed parameters, granularity of displayed logic) by default. However, users may interact with the visual representation in order to show a desired level of detail—for example, users may display or hide branches of logic, and/or display or hide sets of parameters. Details relating to an element of the visual model may be hidden from view by default but can appear in a sliding window or pop-up that appears on-screen when the user clicks on the appropriate element. Users may also zoom in or out of the model, and/or pan across different parts of the model, to examine different parts of the model. Users may also copy or paste branches of logic from one section of the model into another section, or copy/paste branches of logic from a first model into a second model. In some cases, parts of the model may contain links to other parts of the model, such that if a user clicks on a link, the user will automatically be led to another part of the model. A viewing user may interact with a visual representation in at least some of the same ways that the viewing user might interact with the model if it were displayed within a modeling environment. In other words, the visual representation may be configured to mimic how the model would appear if it were displayed within a visual modeling environment. A single internal representation may correspond to multiple visual representations that use different styles or formatting rules to display app logic. For instance, multiple visual representations corresponding to the same internal representation may differ from one another in their use of color, elements that are included or omitted, and use of symbols, shapes, lines, colors, and/or shades to depict logic flow.

Approaches involving the above-described functionalities of visual model-based representations, visual model-based apps, and/or visual models are sometimes understood to be included by a so-called low-code application development platform or low-code app development platform. By way of example, such a low-code application development platform may further be described as software that provides a development environment used to create application software through graphical user interfaces and configuration instead of traditional hand-coded computer programming. A low-code model may enable developers of varied experience levels to create applications using a visual user interface in combination with model-driven logic. Such low-code application development platforms may produce entirely operational apps or require additional coding for specific situations. Low-code app development platforms may reduce the amount of traditional hand coding, enabling accelerated delivery of business apps. A common benefit is that a wider range of people can contribute to the app's development—not only those with formal programming skills. Low-code app development platforms can also lower the initial cost of setup, training, deployment, and maintenance.

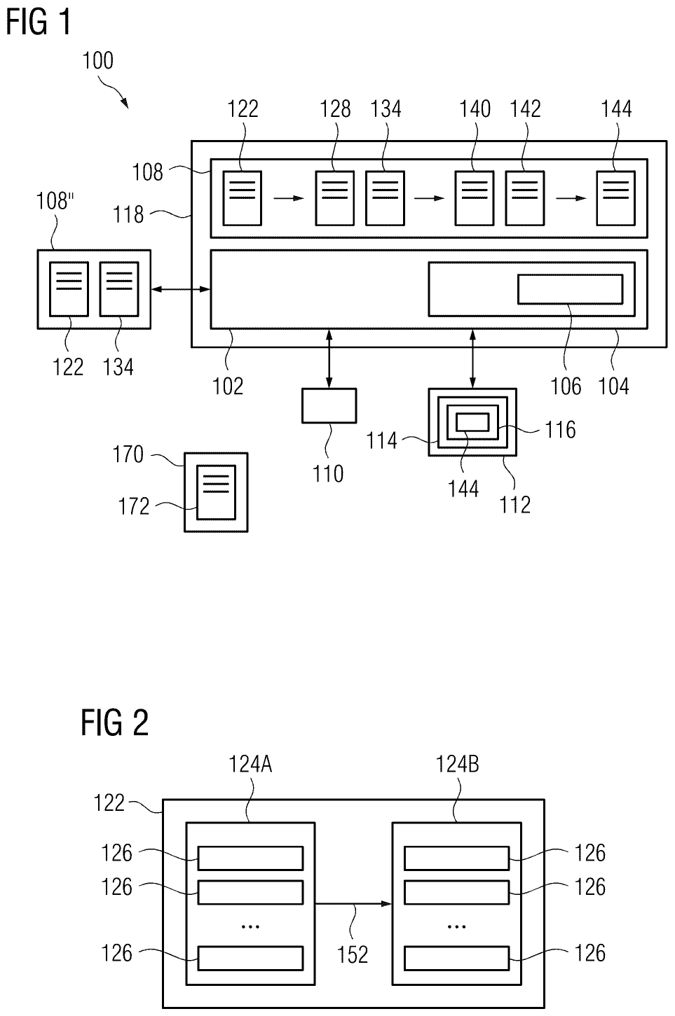

With reference to FIG. 1, a functional block diagram of a first example computer system or data processing system 100 is depicted that facilitates managing an app 120, such as managing an app 120 including an app model 122 and involving a simplified app model 128, in a product system 100. The processing system 100 may include an app management platform 118 which may, in some examples, may include at least one processor 102 that is configured to execute at least one application software component 106 from a memory 104 accessed by the processor 102. The application software component 106 may be configured (i.e., programmed) to cause the processor 102 to carry out various acts and functions described herein, e.g., including the app development functionalities mentioned above. For example, the described application software component 106 may include and/or correspond to one or more components of an application for managing an app 120, such as managing an app 120 including an app model 122 and involving a simplified app model 128, wherein the application software component 106 may, e.g., be configured to generate and store product data in a data store 108 such as a database.

By way of example, the app management platform 118 may be cloud-based, internet-based and/or be operated by a provider providing support for managing an app 120, such as managing an app 120 including an app model 122 and involving a simplified app model 128. In some examples, the user may be located close to the app management platform 118 or remote to the app management platform 118, e.g., anywhere else, e.g., using a mobile device for connecting to the app management platform 118, e.g., via the internet, wherein the mobile device may include an input device 110 and a display device 112. In some examples, the app management platform 118 may be installed and run on a user's device, such as a computer, laptop, pad, on-premises computing facility, or the like.

Examples of product systems that may be adapted to include the app management and/or development, such as managing an app 120 including an app model 122 and involving a simplified app model 128 features described herein, may include the low-code software development platform of Mendix Inc., of Boston, Massachusetts, USA. This platform provides tools to build, test, deploy, iterate, develop, create and manage apps 120 and is based on visual, model-driven software development. However, it should be appreciated that the systems and methods described herein may be used in other product systems (e.g., product lifecycle management (PLM), product data management (PDM), application lifecycle management (ALM) systems) and/or any other type of system that generates and stores product data in a database. Also, examples of databases that may be used as one or more data stores described herein include database server ap-plications such as Oracle, Microsoft SQL Server, or any other type of data store that is operative to store data records.

It should be appreciated that managing an app 120, such as managing an app 120 including an app model 122 and involving a simplified app model 128, may be a challenging and time-consuming process which may require highly skilled developers with many years of training and expert domain knowledge. For example, apps 120 and app models 122 may become increasingly complex and there may yet be a big need to manage a corresponding app 120 or to extend an existing app 120 fast. Further, an increasing lack of skilled developers leads to the necessity to enable or at least facilitate managing an app 120, such as managing an app 120 including an app model 122 and involving a simplified app model 128, for persons without specific software development experience or IT knowledge. Generally, for managing apps 120, such as managing an app 120 including an app model 122 and involving a simplified app model 128, there is a desire for faster and more convenient app development.

To enable the enhanced management of an app 120, managing an app 120, such as managing an app 120 including an app model 122 and involving a simplified app model 128, the described product system or processing system 100 may include at least one input device 110 and at least one display device 112 (such as a display screen). The described processor 102 may be configured to generate a graphical user interface (GUI) 114 through the display device 112. Such a GUI 114 may include GUI elements such as buttons, links, search boxes, lists, text boxes, images, scroll bars usable by a user to provide inputs through the input device 110 that cause managing an app 120, such as managing an app 120 including an app model 122 and involving a simplified app model 128. By way of example, the GUI 114 may include an app management user interface (UI) 116 provided to a user.

In an example embodiment, the app 120 may include an app model 122 that may include a plurality of entities 124 which may be associated with each other, wherein the respective entity 124 may include at least one respective entity attribute 126, and wherein the application software component 106 and/or the processor 102 may be configured to provide an app management UI 116 of an app management platform 118 to a user for managing the app 120.

By way of example, the app model 122 may be understood in the above-described context of model-based app development, wherein the management of the app 120 may, e.g., include the development of the app 120 using the app management platform 118. The app model 122 may, e.g., describe information or data used by the app 120, e.g., in a visual way, e.g., in the form of a graph. Herein, a graph may, e.g., be understood as a structure consisting of a set of objects where some pairs of the objects are in some sense “related”. The objects may be represented by abstractions called vertices, also called nodes or points, and each of the related pairs of vertices is called an edge, also called link or line. Typically, a graph may be depicted in diagrammatic form as a set of dots or circles for the vertices, joined by lines or curves for the edges. In the present context, the app model 122 or the objects or nodes of the graph may include a plurality of entities 124, wherein an entity 124 may, e.g., be compared to a table in traditional SQL. Entities 124 may, e.g., have app attributes 126, which may be thought of as fields, and may have primitive types like string, int, and date-time. Entities 124 may relate to each other either 1-1, 1-*, or *-* so that the graph may have corresponding edges. The edges of the graph may also be considered to be associations 152 as sketched in FIG. 2 linking two or more entities 124. In some examples, the app model 122 and the graph may be used interchangeably.

Further, the app model 122 may, e.g., be a data model which may abstract the structure of a relational database management system (RDBMS) which may store the industrial or business data which may power the app 120. As mentioned above, the app model 122 may include a plurality of the above-mentioned entities 124 with their relationships to other entities 124 represented by associations 152, as sketched in FIG. 2. In some examples, the associations 152 may allow entities 124 to communicate with one another. By way of example, the respective entity 124 may have one or more entity attributes 126 which may correspond to properties of the respective entity 124. The app model 122 may, e.g., include a rule, a workflow, a logic, or a functionality and may, e.g., describe how entities 124 may relate to each other in terms of data manipulation, e.g., to derive output data from input data using an algorithm, wherein the algorithm may, in some examples, correspond to the respective rule, workflow, logic, or functionality. By way of example, the app model 122 may, e.g., characterize (at least some aspects) the app 120 and/or functionalities of the app 120, wherein in further examples, the app model 122 may include one or more workflows for processing data related to the entities 124 or pages of the app 120, wherein the pages may serve to display information of the entities 124 or information derived from the entities 124, to an app user, e.g., via a UI of the app 120.

The app 120 may, e.g., be used by an end user for industrial and/or business purposes. An industrial purpose may, e.g., be to use the app 120 for analyzing, monitoring, controlling and/or managing an industrial field device or plant including several such fields devices, wherein the mentioned devices or plants may correspond to a target device 160 which is explained in more detail below. A business purpose may, for example, be to use the app 120 for shopping or retail, e.g., to generate or manage customer orders of a hardware or software product.

In the context of an industrial example, the app model 122 may, e.g., include control functionalities to control a target device 160 on which the app 120 may be deployed and run or which may be controlled via control signals provided by the deployed and running app 120. Herein, the control functionalities included in the app model 122 may, e.g., rely on input data received by the target device 160 or another device which is associated or coupled with the target device 160, wherein the app 120 may, according to the app model 122, process the input data to determine the control signals in line with the control functionalities. In another example in the industrial domain, the app model 122 may, e.g., include monitoring functionalities according to which, based on input data received by the target device 160 or another device which is associated or coupled with the target device 160, an analysis and a comparison against predefined threshold values may be done to monitor the condition of the target device 160 or the other device, e.g., to determine if the respective device is operating as expected or abnormally, e.g., due to wear, a defect or a malfunction of the respective device.

According to an industrial example, one of the entities 124 included in the app model 122 may, e.g., include entity attributes 126 describing some properties of the target device 160, such as an identifier, and a type of target device 160 (e.g., a PLC controlling an electric motor). In this example, the app 120 may eventually be deployed and run on the target device 160 (here: the PLC). The device coupled with the target device 160 may, e.g., be another entity 124 with the following entity attributes 126: an identifier, a type of device (e.g., an electric motor), a rated output power (e.g., 5 kW), and a maximum rotational speed (e.g., 3000 rpm). Another of the entities 124 included in the app model 122 may, e.g., describe some properties of a complex machine including the target device 160, wherein the target device 160 drives the complex machine with a certain actual rotational speed. To control the coupled device (here: the electric motor), the actual rotational speed of the coupled device may be determined, e.g., by the target device 160 (here: the PLC), wherein in simple examples, a comparison with the maximum rotational speed may be done and, if the actual rotational speed is larger than the maximum rotational speed, the target device 160 may control the coupled device to reduce the actual rotational speed below the maximum rotational speed. Herein, the comparison and the generation and transmission of the corresponding control signal may be performed by a corresponding algorithm which may be considered as a rule, workflow, logic, or functionality included in the app model 122.

Further, the app model 122 may include an API (application programming interface) describing how the app 120 may communicate with another app or more generally with another computer program, computer programs component, or data resource. In some examples, the input data and/or the output data of a respective rule, workflow, logic, or functionality may, e.g., be communicated from or to and another data resource.

In the context of the above example of a PLC controlling an electric motor, the app model 122 may include a workflow including at least three workflow items or steps which may, e.g., be executed iteratively: first, the actual rotational speed of the coupled device (here: the electric motor) may be determined, wherein in some examples, the corresponding information of the actual rotational speed may be retrieved via an API, e.g., to communicate with the target device 160 (here: the PLC). Second, the determined actual rotational speed may be compared with the maximum rotational speed as defined in the entity attributes 126 of the coupled device. And third, the actual rotational speed of the coupled device may be adapted, if necessary, thus controlling the coupled device. Such a workflow may involve a decision, wherein depending on input data, a decision to execute a first activity (here: adapt the actual rotational speed of the coupled device) or a second activity (here: do nothing) may be determined.

As mentioned above, the app management platform 118 may provide or include the above-described functionalities of the development and the creation of an app 120, such as creating an app 120 including an app model 122. In some examples, the app management platform 118 may support visual model-based representations, visual model-based apps, and/or visual models and, by way of example, may be a visual model-based app management or development platform or a low-code app management or development platform. The app management UI 116 may provide an interactive user interface of the app management platform 118 which supports and enables the user to develop the app 120. By way of example, the app 120 may be or include a software program which on execution performs specific desired tasks.

In some examples, the application software component 106 and/or the processor 102 may further be configured to provide the app model 122.

The above-described app model 122 may be provided and stored in the data store 108 of the app management platform 118, e.g. by the user using the app management UI 116 and/or the input device 110. Herein, by way of example, the app model 122 and the corresponding app 120 may be developed by the user of the app management platform 118. In some examples, the app model 122 may be received, e.g., via an application programming interface (API), from another data source 108″ or from the internet.

In further examples, the application software component 106 and/or the processor 102 may further be configured to determine a simplified app model 128 including a respective first table 130 linking the respective entity 124 with respective entity attribute 126 of the respective entity 124, and a second table 132 linking the respective entity 124 with the respective, associated entity 124.

As mentioned above, the app model 122 may include or be arranged as a graph. In some examples, the app model 122 or the corresponding graph may be rather comprehensive and complex in that many entities 124 (or nodes) may be included in a complex structure with many entity attributes 126 and with many correlations (or associations 152 or edges). By way of example, such rather comprehensive and complex app models 122 or graphs may include 20 entities 124, e.g., with in average three entity attributes 126 per entity 124.

The app model 124 may be simplified by determining a simplified app model 128 which may, in some examples, reduce the complexity of the app models 122 or graphs considerably. The simplification of the app model 124 may, e.g., be achieved by assigning the respective entity 124 and the one or more entity attributes 124 of this entity 124 to a first table 130, respectively. Hence, for each entity 124, a respective first table 130 may be established which links the respective entity 124 with the respective entity attribute(s) 126 of the respective entity 124. Further, a second table 132 may be established which links the respective entity 124 with the respective, associated entity 124. Hence, the second table 132 reflects the associations 152 between the entities 124. In this manner, the app model 122 may be broken down into a number of tables included in the simplified app model 128 which may, in some examples, be light-weight and slim in the context of computation and, e.g., the integration of a large language model 142. By way of example, there may be as many first tables 130 as there are entities 124 and there may be one second table 132. The simplified app model 128 may include the mentioned first tables 130 and the mentioned second table 132. By way of example, by linking the respective entity 124 with the respective entity attribute 126, and typically with several respective entity attributes 126, the respective first table 130 may reflect a 1-to-many-relationship. Further, the second table 132 may, e.g., reflect 1-to-1-relationships by linking the respective entity 124 with the respective, associated entity 124.

In some examples, the format of the simplified app model 128 may be based on SQL (Structured Query Language) which is a domain-specific language used to manage data, especially in a relational database management system. SQL may, by way of example, be particularly useful in handling structured data, i.e., data incorporating relations among entities and variables. In the present context, thanks to the SQL basis of the format of the simplified app model 128, the integration of a large language model 142 may further be facilitated since, in some examples, LLMs 142 may be trained on SQL scripts. It should be appreciated that in some examples, the format of the simplified app model 128 may be more concise and briefer than SQL and than the app model 122 thanks to the above-mentioned break down of the app model 122 into a number of tables included in the simplified app model 128.

By way of example, the application software component 106 and/or the processor 102 may further be configured to receive natural language user input 134 via the app management UI 116, wherein the user input 134 is indicative of a query for processing at least one subset 136 of the app model 122 according to a respective processing type 138, wherein the respective subset 136 includes only some of the entities 124 and some of the entity attributes 126.

In some examples, the respective subset 136 includes a part of the entities 124 and a part of the entity attributes 126 included in the app model, so that the subset 136 does not include all the entities 124 and all the entity attributes 126 of the app model 122. To manage the app 120 including the app model 122, the user of the app management platform 118 may provide the user input 134 in natural language, e.g., in written form using a keyboard as the input device 110 and using an input text box of the app management UI 116, wherein oral input may also be possible, e.g. using a microphone as the input device 110. By way of example, if the user provides the user input 134 indicative of the mentioned query, the app management platform 118 may analyze the user input 134 to derive the query. By way of example, the user may want to create a new workflow to process several entities 124 and/or several entity attributes 126 of the app model 122, e.g., in the context of the above industrial controlling example, by adding triggering and sending an alarm message to the user of the app 120 if the actual rotational speed exceeds the maximum rotational speed of 3000 rpm. In some examples, the user's intended processing task only concerns a part of the entities 124 and/or several entity attributes 126 of the app model 122, wherein the concerned part of the app model 122 corresponds to the subset 136 of the app model 122. Herein, in some examples, two or more subsets 136 may at least partially overlap with each other in that two or more subsets 136 include at least one common entity 124, common entity attribute 126, or common pair of entity 124 and related entity attribute 126. In further examples, the user's intended processing task involves a certain processing type 138 which may, e.g., make use of the app model 122 to derive data thereof or which make amendments to the app model 122.

By way of example, the processing types 138 may include: Validation, e.g., ensuring that supplied data, such as the app model 122 or data derived thereof, is correct and relevant. Sorting, e.g., arranging items in some sequence and/or in different sets which may, in some examples, help the user to understand the app model 122 or data derived thereof. Summarization, e.g., reducing detailed data to its main points, which may, in some examples, guide the user to core features of the app model 122 or data derived thereof. Aggregation, e.g., combining multiple pieces of data, e.g., using an existing or new algorithm or workflow to determine output data from input data relating to entities 124 of the app model 122, e.g., as in the above industrial controlling or monitoring example. Analysis, e.g., the collection, organization, analysis, interpretation and presentation of data, e.g., using an existing or new algorithm or workflow to determine output data from input data relating to entities 124 of the app model 122, e.g., as in the above industrial controlling or monitoring example. Further, data relating to entities 124 of the app model 122 or the determined output data may be displayed via an app UI to a user of the app 120. Reporting, e.g., list detail or summary data or computed information, e.g., relating to entities 124 of the app model 122 or the determined output data. Classification, e.g., separation of data into various categories, relating to entities 124 of the app model 122 or the determined output data which may, e.g., be classified in “normal” or various “abnormal”, “malfunction”, “excessive wear”, etc. classes in the above industrial monitoring example. Further examples of processing types 138 are explained below.

In further examples, the user of the app management platform 118 may make selections from predefined processing types 138 or predefined subsets 136 of the app model 122. Such predefined subsets 136 may, e.g., cluster these entities 124 and/or these entity attributes 126 of the app model 122 into a respective subset 136 which, e.g., relate to certain aspects of the app 120 and/or the use case for which the app 120 may typically be used: in the above industrial example, the entities 124 and/or the entity attributes 126 of the app model 122 may be assigned to a first subset 136 which relates to the rotational speed (e.g., the entities 124 and/or the entity attributes 126 of the actual rotational speed of the machine and of the maximum rotational speed of the electric motor); or the entities 124 and/or the entity attributes 126 of the app model 122 may be assigned to a second subset 136 which relates to communication with other devices (e.g., information on the communication protocol or the network address of the PLC, of a gateway, etc.). By way of example, the predefined processing types 138 or predefined subsets 136 of the app model 122 may be displayed to the user via the app management UI 116, and wherein a combination of natural language user input and a selection from predefined processing types 138 or predefined subsets 136 of the app model 122 may be possible. In further examples, the user may provide the user input 134 by chatting with a chatbot which may, e.g., be understood to be a software application or web interface that is designed to mimic human conversation through text or voice interactions.

In some examples, the application software component 106 and/or the processor 102 may further be configured to determine a respective third table 140 linking two entities 124, two entity attributes 126, or one entity 124 and one entity attribute 126 included by the respective subset 136, respectively, using the user input 134, the respective first table 130 relating to the entities 124 and the entity attributes 126 of the respective subset 136, and the second table 132, and optionally a large language model 142.

For the determination of the respective third table 140, by way of example, the suitable respective subset 136 within the app model 122 may be determined which may, e.g., be done using the simplified app model 128 including the first tables 130 and the second table 132. Herein, the respective subset 136 may be suitable if the respective subset 136 matches sufficiently well the received user input 134. Further, in some examples, the large language model (LLM) 142 may be used to determine the respective third table 140.

Herein, a large language model (LLM) 142 may be understood as a computational model capable of language generation or other natural language processing tasks. As language models, LLMs 142 may acquire these abilities by learning statistical relationships from vast amounts of text during a self-supervised and semi-supervised training process. In some examples, LLMs 142 may use artificial neural networks built with a decoder-only transformer-based architecture, which may enable efficient processing and generation of large-scale text data. These models may, e.g., acquire knowledge about syntax, semantics, and ontologies. The artificial neural networks of LLMs 142 may, e.g., contain a billion to a trillion weights, and are (pre-)trained using self-supervised learning and semi-supervised learning. Some notable LLMs 142 include among others OpenAI's GPT series of models, Google's Gemini, Meta's LLaMA family of models, and IBM's Granite.

The suitability of the respective subset 136 or eventually of the elements of the respective third table 140 may, e.g., be determined using the user input 134, the respective first table 130, and the second table 132, e.g., using an according algorithm or the LLM 142. Herein, in some examples, the respective first table 130 and the second table 132 may be static for a given app model 122 or a derived simplified app model 128, whereas the user input 134 may, of course, vary depending on the user's current processing intent. Consequently, depending on the user's current processing intent, e.g., using the LLM 142, different third tables 140 may be determined linking different pairs of entities 124 and/or entity attributes 126.

In the above industrial example, e.g., if the user input 134 is indicative of a subset 136 of the app model 122 and hence of the simplified app model 128 relating to control of the rotational speed, the entity attribute 126 indicating the actual rotational speed of the entity 124 “machine” may be linked via the corresponding third table 140 with the entity attribute 126 indicating the maximum rotational speed of the entity 124 “electric motor”. By way of example, the entity 124 “machine” may also be linked via the corresponding third table 140 with the entity 124 “electric motor”. In this example, the processing type 138 indicated by the user input 134 may be to introduce an additional functionality or workflow to the app 120, e.g., to trigger and send an alarm message to the user of the app 120 if the actual rotational speed exceeds the maximum rotational speed of 3000 rpm.

By way of example, the respective third table 140 may reflect which entities 124 and which entity attributes 126 of the simplified app model 128 may be needed and sufficient to execute the user query as expressed in the received user input 134. Accordingly, the respective third table 140 may omit all the other entities 124 and entity attributes 126 of the simplified app model 128 which may not be needed to execute the user query as expressed in the received user input 134 which contributes to achieve a lightweight and slim approach in the context of computation and, e.g., the integration of a large language model 142. Further, the suggested approach may, e.g., help to scale to very large app models 122 with many entities 124, entity attributes 126 and/or associations 152 between the entities 124. Conversely, for app models 122 of regular size, the suggested approach may, e.g., help to speed up the determination and consume less computation, memory and format token resources, wherein there may only be a limited amount of format tokens to carry out processing tasks with a LLM 142.

In some examples, the format of the respective third table 140 may be based on SQL. Thanks to the SQL basis of the format of the respective third table 140, the integration of a large language model 142 may further be facilitated since, as mentioned above, LLMs 142 may be trained on SQL scripts. It should be appreciated that in some examples, the respective third table 140 may be more concise than SQL and than the app model 122 thanks to the above-mentioned break down of the app model 122 into a number of tables included in the simplified app model 128.

By way of example, the respective association 152, e.g., a respective entry in the first table 130, the second table 132, or the third table 140, may use a simplified version of SQL, e.g., in the following form: “ASSOCIATION: Module.TestTable1/Module. TestTable1_TestTable2/Module.TestTable2”, wherein the first part (i.e., before the underscore) may indicate the owner of the association.

In some examples, another format may be used which may be less efficient with respect to involved computation resources and the integration of the LLM 142:“ALTER TABLE ProductsAndOrderModule.DeliveryStatus ADD FOREIGN KEY (ProductsAndOrderModule.DeliveryStatus_ProductsAndOrderModule.Order) REFERENCES ProductsAndOrderModule.Order(ID);”

By way of example, the respective third table 140 may be determined by matching the entities 124 and the entity attributes 126 of the simplified app model 128 with the received user input 134, e.g., with the help of the LLM 142. The respective match may, e.g., indicate that a pair of a particular entity 124 or a particular entity attribute 126 with another particular entity 124 or another particular entity attribute 126 has sufficiently good agreement or similarity with the user's query to process at least one subset 136 of the app model 122 according to a certain processing type 138. The user may provide the user input 134 indicative of the mentioned query, wherein the user input 134 may, in some examples, be compared with available, pre-defined queries and relating to typical subsets 136 and typical processing types 138, e.g., relating to controlling or monitoring field devices or target devices 160 in the above industrial example. The pre-defined queries, typical subsets 136 and/or typical processing types 138 may then be used, e.g., together with the LLM 142, to identify one or more of the typical subsets 136 including pairs of entities 124 and/or entity attributes 126 which best fit to the user's intend as expressed in the received user input 134.

In further examples, to perform the described matching, the application software component 106 and/or the processor 102 may further be configured to determine a respective similarity value between the respective pair of entities 124 and/or entity attributes 126 and the received user input 134, and to determine the respective match based on the determined similarity values. The respective similarity value may, e.g., be understood as a real-valued function that quantifies the similarity between two objects, here the respective pair of entities 124 and/or entity attributes 126 and the received user input 134. In some examples, the similarity may further be understood as the inverse of distance metrics: the similarity values may take on large values for similar objects and either zero or a negative value for very dissimilar objects. Though, in more broad terms, a similarity function may also satisfy metric axioms. By way of example, the cosine similarity may be used as a measure for real-valued vectors for information retrieval to score the similarity of the respective pair of entities 124 and/or entity attributes 126 and the received user input 134. The respective matching pair of entities 124 and/or entity attributes 126 may then be included in the respective third table 140.

By way of example, the application software component 106 and/or the processor 102 may further be configured to determine processed data 144 associated with the respective subset 136 using the processing type 138, the respective third table 140, and the large language model 142.

Herein, the processing type 138 and the respective third table 140 may be used as input to the LLM 142 which may then provide the processed data 144 as output. By way of example, the LLM 142 may use the values or arguments of the pairs of entities 124 and/or entity attributes 126 of the respective subset 136 included in the third table 140 as input, e.g., the actual rotational speed of the entity 124 “machine” and the maximum rotational speed of 3000 rpm of the entity 124 “electric motor” in the above industrial controlling or monitoring example. E.g., based on the two rotational speed values, processed data 144 may be determined by the LLM 142 which may further use the processing type 138 as input, wherein the processed data 144 may include a control signal which is to be sent to the PLC to reduce the actual rotational speed of the machine and the electric motor or an alarm message which is to be triggered and sent to the user of the app 120 if the actual rotational speed exceeds the maximum rotational speed of 3000 rpm, respectively. Further examples of such processed data 144 are explained below and may, e.g., include generating test data, creating a workflow or a page from an app model 122, modify an existing app model 122, or creating SQL queries for citizen users.

As explained above, the suggested approach may, e.g., help to scale to very large app models 122 with many entities 124, entity attributes 126 and/or associations 152 between the entities 124. This may, e.g., be achieved thanks to the respective third table 140 reflecting which entities 124 and which entity attributes 126 of the simplified app model 128 may be needed and sufficient to execute the user query as expressed in the received user input 134. The suggested approach may be light-weight and slim in the context of computation and, e.g., the integration of a large language model 142, e.g., since the LLM 142 is only provided with input which is relevant to the present received user input 134 and not distracted with unnecessary details, e.g., since the respective third table 140 may omit all the other entities 124 and entity attributes 126 of the simplified app model 128 which may not be needed to execute the user query as expressed in the received user input 134. Hence, the suggested approach may help to speed up the determination and consume less computation, memory and format token resources and/or make more complex app models 122 accessible for the management of the app 120.

In some examples, the application software component 106 and/or the processor 102 may further be configured to display the processed data 144.

By way of example, the processed data 144 may be displayed via the app management UI 116 to the user of the app management platform 118. In further examples, the processed data 144 may alternatively or additionally be displayed via a UI of the app 120 to the user of the app 120, wherein the app 120 may be deployed and run on a target device 160 as is explained in more detail below.

In the above industrial example, if the actual rotational speed exceeds the maximum rotational speed of 3000 rpm, the processed data 144 may include an information on sending a control signal to the PLC to reduce the actual rotational speed of the machine and the electric motor. By way of example, if the actual rotational speed exceeds the maximum rotational speed of 3000 rpm, the processed data 144 may include the mentioned an alarm message.

In some examples, the processed data 144 may only optionally be displayed, e.g., upon a specific request of the user of the app management platform 118 or the deployed and running app 120.

In further examples, the application software component 106 and/or the processor 102 may further be configured to decompose the respective subset 136 is into a plurality of sub-subsets 136′; to determine the respective processed data 144 associated with the respective sub-subset 136′ using the processing type 138, the respective third table 140, and the respective sub-subset 136′, and optionally the large language model 142; and to compose the respective processed data 144 associated with the respective subset 136 by joining the respective processed data 144 associated with the respective sub-subset 136′ using the respective third table 140.

In some examples, chopping the respective subset 136 into smaller sub-subsets 136′ may contribute to achieve further savings with respect to computation, memory and format token resources, e.g., when integrating the LLM 142 to determine the respective processed data 144. The smaller sub-subsets 136′ may then, e.g., one by one, be used as input of the LLM 142 along with the processing type 138 and the respective third table 140 to determine the corresponding fraction of the respective processed data 144, e.g., the fraction of the respective processed data 144 associated with the respective, input sub-subset 136′. In this way, the complete set of respective process data 144 may be determined one by one for each respective, input sub-subset 136′, wherein eventually, the respective processed data 144 associated with the respective subset 136 may be determined by joining the respective processed data 144 associated with the respective sub-subset 136′ using the respective third table 140.

By way of example, joining the respective processed data 144 associated with the respective sub-subset 136′ using the respective third table 140 may be done by a post processor 154, optionally using the LLM 142. By way of example, by post-processing, the data is joined across the associations by programmatically generating association table entries. Each association table entry is basically a pair of identifiers referencing the two items that are being joined. There is an association table for each association. The resulting data can be projected to whatever format is required for the ultimate data ingestion, such as SQL INSERT statements or CSV or JSON etc. The resulting quality can be higher since the format of the simplified app model 128 is minimalistic and the LLM 142 can focus on the main task at hand.

The post processor 154 may assemble the chunks of the processed data 144 for the different entities 124. Associations 152 may be populated by generating entries to point to the LLM 142 generated entity records. Further, high-volume data may be output by re-combining the LLM entity data, and also generating new values for field where it can be arranged can be identified from the LLM generated data. Eventually, the post processor 154 may provide complete and assembled process data 144.

In some examples, the large language model 142 may have a context window limiting the input size of the large language model 142, wherein the context window may be exceeded by the respective subset 136, or the user input 134 jointly with the respective subset 136, and wherein the application software component 106 and/or the processor 102 may further be configured to decompose the respective subset 136 into the plurality of sub-subsets 136′ such that the respective sub-subset 136′, or the user input 134 jointly with the respective sub-subset 136′ does not exceed the context window of the large language model 142.

The above approach of chopping the respective subset 132 into smaller sub-subsets 136′ may, in some examples, be particularly beneficial if the large language model 142 has a context window. Herein, the context window of LLMs 142 may, e.g., be understood as the maximum number of tokens the LLM 142 can take as input when generating responses or output. For example, in GPT-3 the context window size is 2K (2000) and in GPT-4 it is a larger 32K, wherein larger context windows may improve the performance of the LLM 142 and their usefulness across various applications. However, the costs increase of larger context windows appear to increase quadratically as the number of tokens is increased so that saving input size of the LLM 142 may be necessary since, in some examples, the input provided to the LLM 142 is simply too large or too comprehensive, and in further examples, a large input to the LLM 142 may be too costly or economically not be feasible. In this context, the input size of the LLM 142 may, e.g., correspond or be translated into a number of tokens the LLM 142 can take as input, wherein in the present example, the input of the LLM 142 may be the processing type 138 and the respective third table 140. By way of example, the input of the LLM 142 may be the processing type 138 and the pairs of entities 124 and/or entity attributes 126 stored in respective third table 140, the respective subset 136 or the respective sub-subset 136′.

In some examples, the respective subset 136 may already exceed the context window of the LLM 142, wherein in further examples, the respective subset 136 together with the user input 134, e.g., the processing type 138, may exceed the context window of the LLM 142. In such examples, the above approach of chopping the respective subset 132 into smaller sub-subsets 136′ may be applied, i.e., the respective subset 136 may be decomposed into a plurality of sub-subsets 136′. Herein, the decomposition of the respective subset 136 into a plurality of sub-subsets 136′ may be done such that, in some examples, the respective sub-subset 136′ does not exceed the context window of the LLM 142. In further examples, the decomposition of the respective subset 136 into a plurality of sub-subsets 136′ may be done such that the respective sub-subset 136′ together with the user input 134, e.g., the processing type 138, does not exceed the context window of the LLM 142.

In further examples, the respective processing type 138 may include generating test data to test the respective subset 136, wherein the processed data 144 may include test data for testing the respective subset 136.

By way of example, testing the respective subset 136 with test data may be understood in the context of software testing which may be the act of checking whether software satisfies expectations. Software testing may provide objective, independent information about the quality of software and the risk of its failure to a user or sponsor. Further, software testing can determine the correctness of software for specific scenarios. The generation of test data may, e.g., be understood as a contribution to test automation which may be understood as the use of a software separate from the software being tested to control the execution of tests and the comparison of actual outcomes with predicted outcomes. In this context, the software being tested may be the app model 122 or the app 120, and the LLM 142 may be part of the separate software.

In some examples, the test data may include at least one of test procedures, test scenarios, test cases, test datasets, test scripts to use in testing software, or any combination thereof. Further, various aspects of the respective subset 136, e.g., using unit tests to test individual functions of classes, components, or modules used by the respective subset 136 or the app model 122; integration tests to verify that different modules or services used by the respective subset 136 or the app model 122 work well together; functional tests to verify the output of an action included in the respective subset 136 or the app model 122; end-to-end testing to verify that various user flows included in the respective subset 136 or the app model 122 work as expected; acceptance tests to verify that the respective subset 136 or the app model 122 satisfies business requirements, such as running while testing; performance tests to evaluate how the respective subset 136 or the app model 122 performs under a particular workload; smoke tests to check the basic functionality of the respective subset 136 or the app model 122.

By way of example, the user of the app management platform 118 may provide user input 134 indicative of one or more of the above-mentioned testing methods so that the respective processing type 138 may include generating corresponding test data. The LLM 142 may then determine corresponding test data as processed data 144.

In some examples, the application software component 106 and/or the processor 102 may further be configured to determine respective test results 146 using the respective test data and the respective subset 136, wherein optionally, several sets of test data may be determined for several subsets 136, and wherein further optionally, the application software component 106 and/or the processor 102 may further be configured to determine composed test results 146 using the respective test data, the second table 132 and the respective third table 140; and optionally to determine composed test results 146 using the composed test data and the several subsets 136.

The respective test data may then be used, e.g., to carry out one or more of the above-mentioned testing methods to test the respective subset 136 or app model 122 and to generate corresponding test results 146. Herein, the test results 146 may, e.g. indicate how the respective subset 136 on the app model 122 performed under a particular workload, e.g., in the above industrial example, using live data of the actual rotational speed of the machine, e.g., in the form of high frequency time series data, and controlling or monitoring the electric motor in real time or at least close to real time. The respective test may, e.g., be performed by the app management platform 118 which may mimic the behavior of the target device 160 on which the app 120 is to be deployed and run, wherein the app management platform 118 may, e.g., provide computing and memory resources for the test execution which correspond to the computing and memory resources of the target device 160. Further, the respective test may, e.g., be executed for typical kinds of target devices 160, such as available series of PLCs and the like.

By way of example, determining the composed test results 146 may be done by the above-mentioned post processor 154, optionally using the LLM 142.

By way of example, wherein the processing type 138 may include determining at least one workflow for processing the respective entity 124 included by the respective subset 136 or determining at least one page for displaying information derived from respective the entity 124 included by the respective subset 136 via an app UI, wherein the processed data 144 may include the respective workflow or the respective page.

In some examples, the respective workflow may describe how entities 124 may relate to each other in terms of data manipulation, e.g., to derive output data from input data using an algorithm, wherein the algorithm may, in some examples, correspond to a certain rule, logic, or functionality. Further, the respective page may serve to display information of the entities 124 or information derived from the entities 124, to an app user, e.g., via a UI of the app 120. By way of example, the app model 122 may, e.g., already include a respective workflow and/or a respective page which may then be updated according to the received user input 134. In further examples, a new respective workflow and/or a new respective page may be created and optionally added to the app model 122 according to the received user input 134.

As already mentioned in the above industrial example, the user may want to create a new workflow to process several entities 124 and/or several entity attributes 126 of the app model 122 by adding triggering and sending an alarm message to the user of the app 120 if the actual rotational speed exceeds the maximum rotational speed of 3000 rpm. In this example, a new workflow for monitoring the actual rotational speed and creating an alarm if the maximum rotational speed of 3000 rpm is exceeded may be determined, wherein further a new page may be determined to be displayed in the UI of the app 120 to display the alarm message to the user of the app 120, and wherein optionally the generation of the page and the display of the alarm may be performed through another newly created workflow.

In some examples, the determination of a new workflow may include creating one or more additional entities 124 with one or more entity attributes 126, respectively, wherein the respective additional entity 124 may be associated with at least one other additional or already existing entity 124. In the above industrial example, an additional entity 124 may correspond to the alarm with the example entity attributes 126 “severity”, “incident type”, “device”, “actual rotational speed”, “alarm recipients”, “mitigation measures”, etc. and with an association to the entity 124 “electric motor” and/or the entity 124 “machine”.

In some examples, the application software component 106 and/or the processor 102 may further be configured to determine a respective updated subset 136 including the determined respective workflow and/or the determined respective page; and to determine an updated app model 122 including the respective updated subset 136.

The respective updated subset 136 may, e.g., updating entities 124, entity attributes 126, and/or associations which are amended or newly created for the determined workflow or page.

By way of example, the app model 122 may, e.g., already include a respective workflow and/or a respective page which may then be updated according to the received user input 134. In further examples, a new respective workflow and/or a new respective page which be created and optionally added to the app model 122 according to the received user input 134.

By way of example, the processing type 138 may include determining a respective updated subset 136 including at least one new or updated entity 124, entity attribute 126 and/or association 152 between two entities 124, wherein the processed data 144 may include the respective updated subset 136.

In some examples, the user may provide user input 134 to make amendments to the existing app model 122, e.g., in the above industrial example, if the electric motor is replaced by another electric motor with different specifications or if the set-up of the machine is amended more fundamentally, e.g., by adding a conveyor belt and a gear box which are driven by the electric motor, respectively. In such examples, the received user input 134 may involve determining one or more new or updated entities 124, entity attributes 126 and/or associations 152 between two entities 124 which may be included in the respective updated subset 136. For example, two new entities 124 “gear box” and “conveyor” may be created, linked with respective associations 152 with the “electric motor” entity 124 and may be described and identified with suitable entity attributes 126.

Similar amendments may occur in the above example of determining at least one workflow or at least one page.

In further examples, several updated subsets 136 may be determined, wherein the application software component 106 and/or the processor 102 may further be configured to determine a composed updated app model 122 using the several updated subsets 136, the second table 132 and the respective third table 140.

By way of example, determining the composed updated app model 122 may be done by the above-mentioned post processor 154, optionally using the LLM 142.

In some examples, the application software component 106 and/or the processor 102 may further be configured to develop the app 120 using the respective updated subset 136.

Using the respective updated subset 136, the app 120 may be developed using the app management platform 118. Herein, the app management platform 118 together with the simplified app model 128 and the integration of the LLM 142 may, in some examples, be particularly suitable to support non-expert users to manage the app 120, e.g., to develop the app 120 according to the received user input 134 and the corresponding user intent. Especially for non-expert users, providing their user input 134 in natural language and, e.g., not using algorithms, step-by-step specifications of procedures, or writing code in one or more programming languages, may make the suggested approach very accessible, convenient and efficient.

By way of example, the application software component 106 and/or the processor 102 may further be configured to deploy the app 120 on a target device 160.

In some examples, the respective target device 160 may be physically connected or communicatively connected to another device or connected such, that the respective target device 160 may at least detect input data from the other device, e.g., by optically inspecting the other device. The respective target device 160 and/or the other device may, in some examples, be or include a sensor, an actuator, such as an electric motor, a valve or a robot, an inverter supplying an electric motor, a gear box, a programmable logic controller (PLC), a communication gateway, and/or other parts or components relating to industrial automation products and industrial automation in general. The respective target device 160 may be part of a complex production line or production plant, e.g., a bottle filing machine, conveyor, welding machine, welding robot, etc. In some examples, if the other device belongs to a lower level of the automation pyramid, such as the sensor/actuator or the field level, then the respective target device 160 may belong to a higher level of the automation pyramid, such as field level or the control level.

By way of example, the respective target device 160 may have an internal data store 108′ in which the deployed and operable app 120 may be stored. The respective target device 160 may, by way of example, further include a processor 102′ and a display device 112′. The described processor 102′ may be configured to generate a target device GUI 114′ through the display device 112′, wherein the GUI 114′ may include a target device operation UI provided to a user of the target device 160. The developed and deployed app 120 may, e.g., have an app UI 116′ which may, e.g., be displayed to the user of the target device 160 via the target device operation UI. In some examples, the target device 160 may include a corresponding UI 116′ capable of outputting information of the app 120 optically, haptically or audibly.

Further, the app 120 may be understood as deployed if the activities which are required to make this app 120 available for use by the app end user on the respective target device 160 are completed. The app deployment process may include several interrelated activities with possible transitions between them. These activities may occur at the producer side (e.g., by the app developer) or at the consumer side (by the app user or end user) or both. In some examples, the app deployment process may include at least the release of the app 120 and the installation and the activation of the app 120. The release activity may follow from the completed development process and is sometimes classified as part of the development process rather than deployment process. It may include operations required to prepare a system (here: e.g., the app management platform 118 or an online app store) for assembly and transfer to the computer system(s) (here: e.g., the respective target device 160) on which it will be run in production. Therefore, it may sometimes involve determining the resources required for the system to operate with tolerable performance and planning and/or documenting subsequent activities of the deployment process. For simple systems, the installation of the app 120 may involve establishing some form of command, shortcut, script or service for executing the software (manually or automatically) of the app 120. For complex systems, it may involve configuration of the system—possibly by asking the end user questions about the intended app use, or directly asking them how they would like it to be configured—and/or making all the required subsystems ready to use. Activation may be the activity of starting up the executable component of software or the app 120 for the first time (which is not to be confused with the common use of the term activation concerning a software license, which is a function of Digital Rights Management systems).

In further examples, the app 120 including the app model 122 may be deployed and run on the target device 160, wherein the deployed and running app 120 may then be used to analyze, monitor, control, and/or operate the target device 160 or coupled devices.

In further examples, the respective processing type 138 may include generating a respective query relating to the respective subset 136, wherein the query is formatted according to a query language, wherein the processed data 144 may include the respective query relating to the respective subset 136.

For simplicity and to differentiate from the query include in the user input 134, the query which is formatted in a query language is called QL query. By way of example, the respective QL query may involve retrieving information from the app model 122 or the respective subset 136. In the above industrial example, the user may, e.g., want to get information on the associations 152 of the entity 124 “electric motor” which may indicate the relations and interactions of the electric motor within the machine. Further the user may, e.g., want to get information on the entity attributes 126 of the entity 124 “electric motor” which may indicate the type of electric motor is currently used in the machine. In some examples, the user may, e.g., want to get information on actual rotational speed of the machine so that the corresponding entity attribute 126 of the entity 124 “machine” is of interest.

According to the suggested approach, the respective subset 136 using the processing type 138, the respective third table 140, and the LLM 142 may be used to determine the respective desired QL query as processed data 144. By way of example, the respective QL query may be formatted in SQL or OQL (Object Query Language) which is a query language standard for object-oriented databases modeled after SQL and developed by the Object Data Management Group (ODMG).

In some examples, the application software component 106 and/or the processor 102 may further be configured to determine respective query results 148 using the QL query and the respective subset 136. In some examples, for the determination of the respective query results 148 the received user input 134 and/or the LLM 142 may further be used.

By way of example, a user may want to provide natural language user input 134 to create a SQL query relating to the app model 122. According to the suggested approach, a suitable SQL query may be determined which may then be used by the user to eventually receive the desired data and who cannot create SQL themselves because of lack of programming skills.

In further examples, the application software component 106 and/or the processor 102 may further be configured to receive further user input 150 indicative of an amended query via the app management UI 116; and to determine amended processed data 144′ using the further user input 150. Optionally the amended processed data 144′ may be displayed to the user via the app management UI 116 or to the user of the app 120 the UI of the app 120.

By way of example, the LLM 142 may be trained with other app models 122 of other apps 120, wherein the other apps 120 may optionally be developed with model-based app development.

E.g., to increase the efficiency of the integration of the LLM 142 in the management of the app 120, other app models and more generally other apps may be used as knowledge base and hence as input to train the LLM 142. Such an increased efficiency of the integration of the LLM 142 may, in some examples, make the suggested approach slim, resource-efficient with respect to computing and memory resources, and fast. These efficiency increases may, e.g., be achieved by benefitting from the results of other app users who have already managed or developed other apps with other app models. By way of example, the other app models may include a graph, a rule, a workflow, a logic, a function, a user interface, an API, a functionality, a target operation environment, corresponding entities with entity attributes and associations of the other app, wherein optionally one or more of these other app model characteristics may further be linked to use cases of the other app, such as business or industrial uses cases including industrial use cases, such as the above-described controlling or monitoring of a respective target device use case. In further examples, other app models and more generally other apps which have been developed using model-based and/or low-code app development may be used as input to train the LLM 142 so that the LLM 142 may benefit from the advantages of this app management approach.

It should be appreciated that the described the application software component 106 and/or the processor 102 may carry out an analogous method of managing an app 120, such as managing an app 120 including an app model 122 and involving a simplified app model 128, in a product system 100. Also, the explained examples may be combined to obtain a more detailed method of managing an app 120, such as managing an app 120 including an app model 122 and involving a simplified app model 128. Further, a computer-readable medium 170 which may include a computer program product 172 is shown in FIG. 1, wherein the computer program product 172 may be encoded with executable instructions, that when executed, cause the computer system 100 or and/or the app management platform 118 to carry out the described method.

Among the advantages of the suggested method is that the suggested approach may, e.g., involve a simplified app model 128 which may still scale to very large app models 122 with many entities 124, entity attributes 126 and/or associations 152 between the entities 124. In some examples, if the original app model 122 is used instead of the simplified app model 128, the LLM 142 which hit a lower limit of maximum entities 124 and entity attributes 126 which would limit the system 100 to smaller and simpler app models 122. By way of example, thanks to the simplified app model 128, such very large app models 122 may still be processed with the help of LLMs 142 without hitting the context window limits of the LLM 142. Herein, the use of the LLM 142 may, by way of example, generalized much better across different domains or use cases such as the above-mentioned industrial example, and even in previously unseen or on known domains. Hence, further, several use cases are enabled even for very large app models 122, as described above. Conversely, for app models 122 of regular size, the suggested approach may, e.g., help to speed up the determination and consume less computation, memory and format token resources. The LLM 142 may allow to benefit from further advantages, such as its translation capability to generate data in other languages, benefiting from world's knowledge, such as common products and geographic locations, to determine the processed data 144.

By way of example, an app 120 may have a comparably small app model 122 with twelve entities 124, wherein the largest entity 124 has seven entity attributes 126, and wherein the average entity 124 has four entity attributes 126. In this example, using the suggested approach involving the described simplified app model 128 and the LLM 142 may result in a reduction of 79% of JSON (JavaScript Object Notation) format tokens and of 13% of the SQL CREATE TABLE format tokens that the simplified app model 128 requires for the use of the LLM 142 compared to the original app model 122. In another example, an app 120 may have a larger app model 122 with 100 entities 124 and in total 500 entity attributes 126 so that the average entity 124 has five entity attributes 126. In this example, similar reduction rates of format tokens that the simplified app model 128 requires for the use of the LLM 142 compared to the original app model 122 may be achieved. Further, similar reduction rates of format tokens may be achieved in some examples of extra-large app models 122 with hundreds of entities 124 and thousands of entity attributes 126. These reduction rates of format tokens relating to the use of the LLM 142 and the simplified app model 128 illustrate the benefits of the suggested approach to speed up the determination of the processed data 144 or to determine the processed data 144 for much more comprehensive and complex apps 120 and app models 122 which were not accessible before.

FIG. 2 depicts a flow diagram of a first aspect of an example methodology that facilitates managing an app 120, such as managing an app 120 including an app model 122 and involving a simplified app model 128, in a product system 100.

In the depicted example, the app model 122 includes two entities 124A and 124B which have a plurality of entity attributes 126 characterizing the respective entity 124A and 124B. The two entities 124A and 124B are associated with each other via an association 152. By way of example, two entities 124A and 124B may correspond to the PLC and the electric motor explained above in the context of the industrial controlling use case. Further, the app model 122 may be arranged as a graph 136 as depicted in FIG. 2.

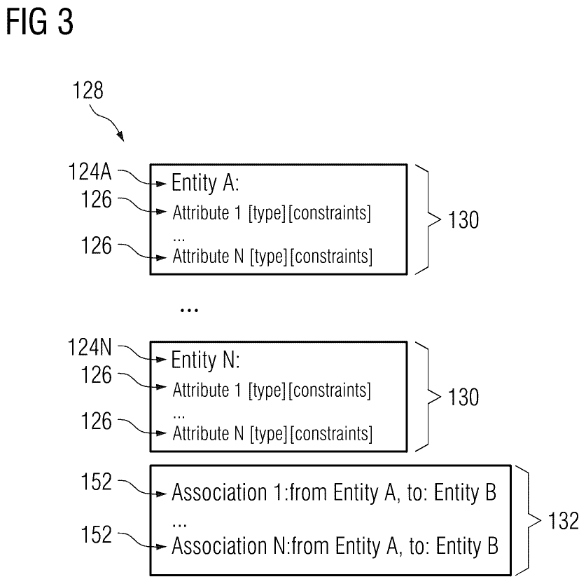

FIG. 3 depicts a flow diagram of a second aspect of an example methodology that facilitates managing an app 120, such as managing an app 120 including an app model 122 and involving a simplified app model 128, in a product system 100.

In the depicted example, the simplified app model 128 includes several first tables 130 linking the respective entity 124, . . . , 124N with the respective entity attributes 126 of the respective entity 124, . . . , 124N, and a second table 132 linking the respective entity 124 with the respective, associated entity 124 via respective associations 152.

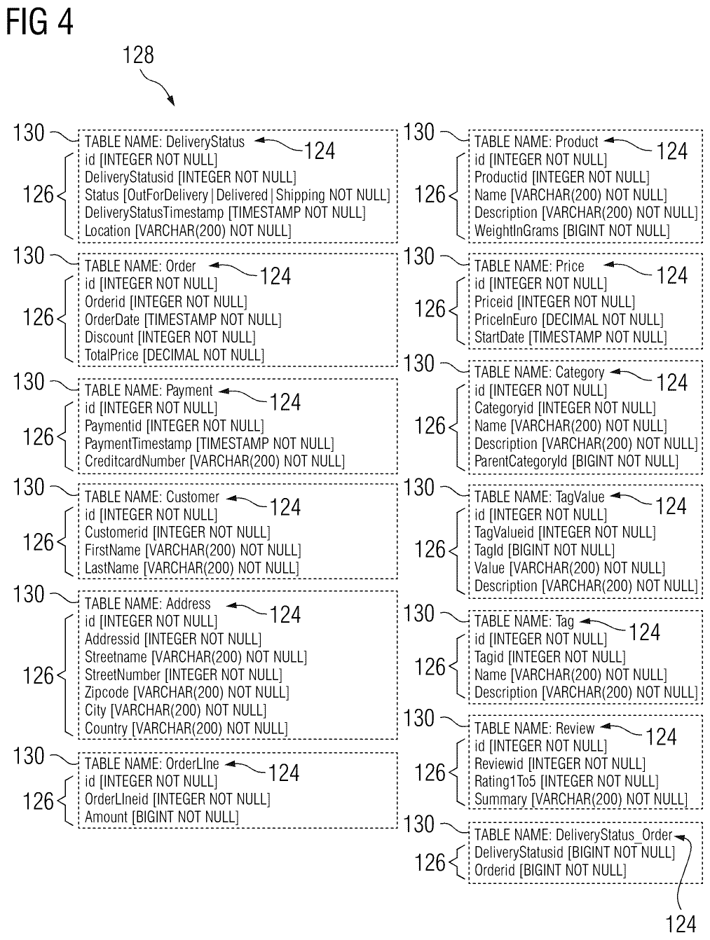

FIG. 4 depicts a flow diagram of a third aspect of an example methodology that facilitates managing an app 120, such as managing an app 120 including an app model 122 and involving a simplified app model 128, in a product system 100.

A plurality of first tables 130 of a more comprehensive, simplified app model 128 is depicted, wherein the respective first table 130 links the respective entity 124 with the respective entity attributes 126 of the respective entity 124.

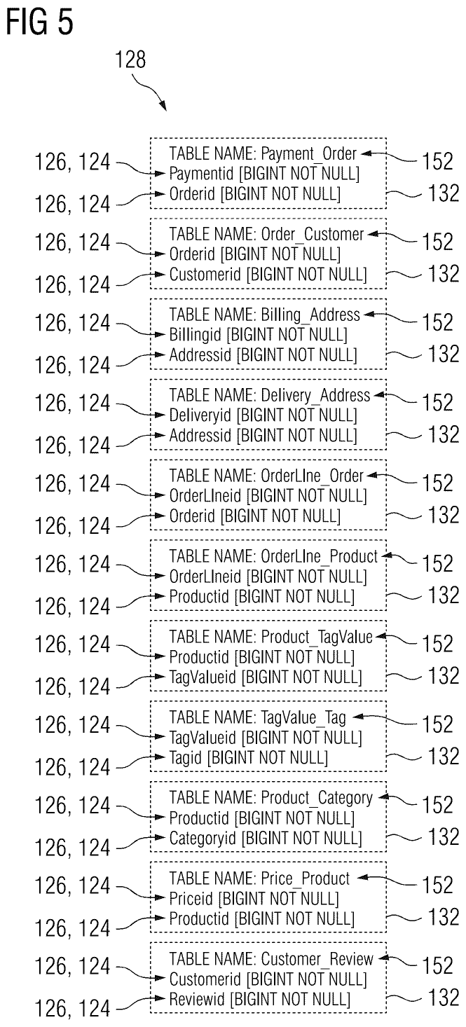

FIG. 5 depicts a flow diagram of a fourth aspect of an example methodology that facilitates managing an app 120, such as managing an app 120 including an app model 122 and involving a simplified app model 128, in a product system 100.

A plurality of second tables 132 of a more comprehensive, simplified app model 128 is depicted, wherein the respective second table 132 links the respective entity 124 and the respective entity attribute 126 with another of the entities 124 and a respective entity attribute 126 via a respective association 152. In some examples, the individual second tables 132 depicted in FIG. 5 may be combined into one single second table 132 linking the respective entity 124 with the respective, associated entity 124.

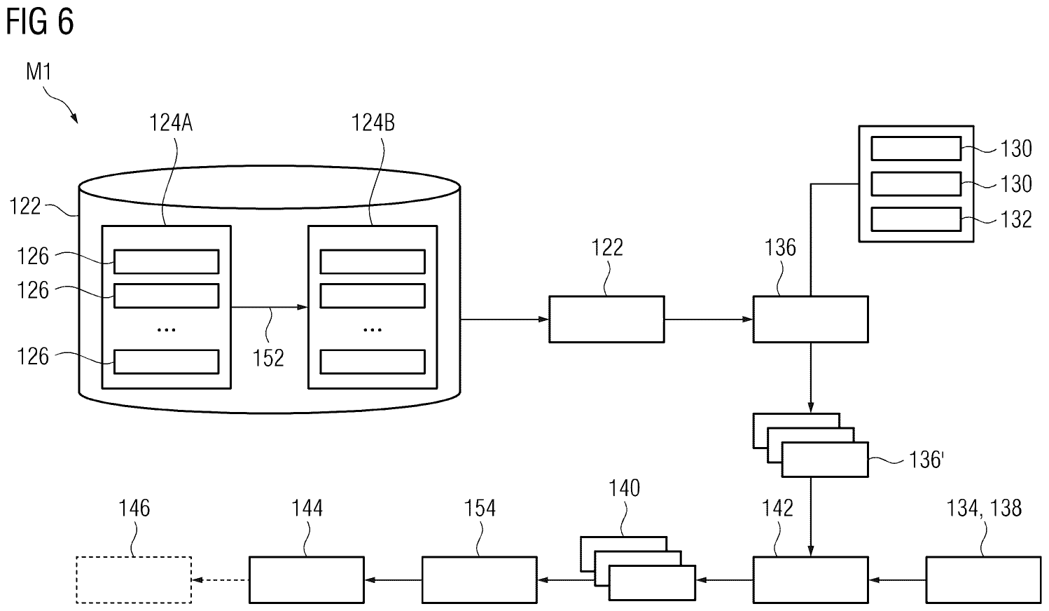

FIG. 6 depicts a flow diagram of a first example methodology M1 that facilitates managing an app 120, such as managing an app 120 including an app model 122 and involving a simplified app model 128, in a product system 100.

The app 120 may include an app model 122 that may include a plurality of entities 124 which may be associated with each other, wherein the respective entity 124 may include one or more respective entity attributes 126. A simplified app model 128 may be determined including a respective first table 130 linking the respective entity 124 with respective entity attribute 126 of the respective entity 124, and a second table 132 linking the respective entity 124 with the respective, associated entity 124. Natural language user input 134 may be received indicative of a query for processing at least one subset 136 of the app model 122 according to a respective processing type 138, wherein the respective subset 136 includes only some of the entities 124 and some of the entity attributes 126. A respective third table 140 may be determined linking two entities 124, two entity attributes 126, or one entity 124 and one entity attribute 126 included by the respective subset 136, respectively, using the user input 134, the respective first table 130 relating to the entities 124 and the entity attributes 126 of the respective subset 136, the second table 132, and a large language model 142. Processed data 144 associated with the respective subset 136 may be determined using the processing type 138, the respective third table 140, and the LLM 142.

Herein, a decomposition of the respective subset 136 is into a plurality of sub-subsets 136′ may be done, wherein the respective processed data 144 associated with the respective sub-subset 136′ may be determined using the processing type 138, the respective third table 140, the respective sub-subset 136′ and the large language model 142. The respective processed data 144 associated with the respective subset 136 may be determined by the post processor 154 by joining the respective processed data 144 associated with the respective sub-subset 136′ using the respective third table 140.

Optionally, if the processing type 138 corresponds to generating test data to test the subset 136 and the processed data 144 corresponds to test data, test results 146 may be determined using the respective test data and the respective subset 136. Further optionally, several sets of test data may be determined for several subsets 136, and wherein optionally, the application software component 106 and/or the processor 102 may further be configured to determine composed test results 146 using the respective test data, the second table 132 and the respective third table 140; and optionally to determine composed test results 146 using the composed test data and the several subsets 136.

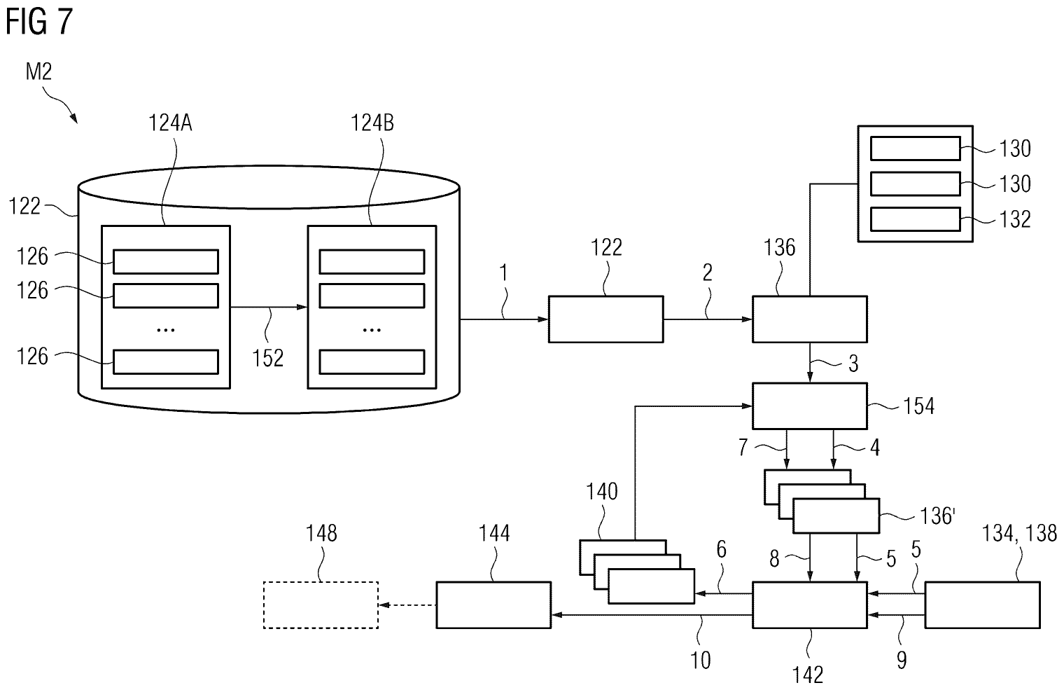

FIG. 7 depicts a flow diagram of a second example methodology M2 that facilitates managing an app 120, such as managing an app 120 including an app model 122 and involving a simplified app model 128, in a product system 100.

The app 120 may include an app model 122 that may include a plurality of entities 124 which may be associated with each other, wherein the respective entity 124 may include one or more entity attributes 126. First, a simplified app model 128 may be determined including a respective first table 130 linking the respective entity 124 with respective entity attribute 126 of the respective entity 124, and a second table 132 linking the respective entity 124 with the respective, associated entity 124. Second, a respective subset 136 including only some of the entities 124 and some of the entity attributes 126 may be determined, wherein optionally, natural language user input 134 may be received indicative of a query for processing the respective subset 136 of the app model 122 according to a respective processing type 138. Third and fourth, the post processor 154 may chop the respective subset 136 into smaller sub-subsets 136′ which are used as input of the LLM 142 in step 5 along with the user input 134. Sixth, a respective third table 140 may be determined linking two entities 124, two entity attributes 126, or one entity 124 and one entity attribute 126 included by the respective subset 136, respectively, using the user input 134, the respective first table 130 relating to the entities 124 and the entity attributes 126 of the respective subset 136, the second table 132, and the LLM 142. If the processing type 138 includes generating a respective QL query relating to the respective subset 136 or sub-subset 136′, the QL query corresponding to the processed data 144 may be determined by the LLM 142 (steps 7, 8 and 10). Herein, the QL query may be formatted according to a query language, such as SQL or OQL.

Optionally, if the processing type 138 corresponds to generating a respective QL query relating to the respective subset 136 or sub-subset 136′ and the processed data 144 corresponds to the QL query, query results 148 may be determined using the respective QL query and the respective subset 136.

In further examples, a very large app model 122 can be supported by first chunking or chopping a request to the LLM 142 to decide which entities 124 and attributes 126 are relevant to the natural language request in form of the user input 134. The filtered list of entities 124 and attributes 126 may then be passed along with the original natural language request in form of the user input 134 to the LLM 142, to produce the technical QL query for the required language (SQL or OQL etc.) as the processed data 144. Because the app model 122 has been prefiltered in this manner, the LLM 142 may, e.g., generate technical QL queries for much larger app models 122 than would otherwise be feasible. By way of example, the quality of the generated QL query can be higher since the format of the simplified domain model 128 may be minimalistic and the app model 122 has been filtered down to the parts that are relevant to the natural language request in form of the user input 134. So, the LLM 142 can focus on the main task at hand and produce better results and also ultimately handle very large app models 122.

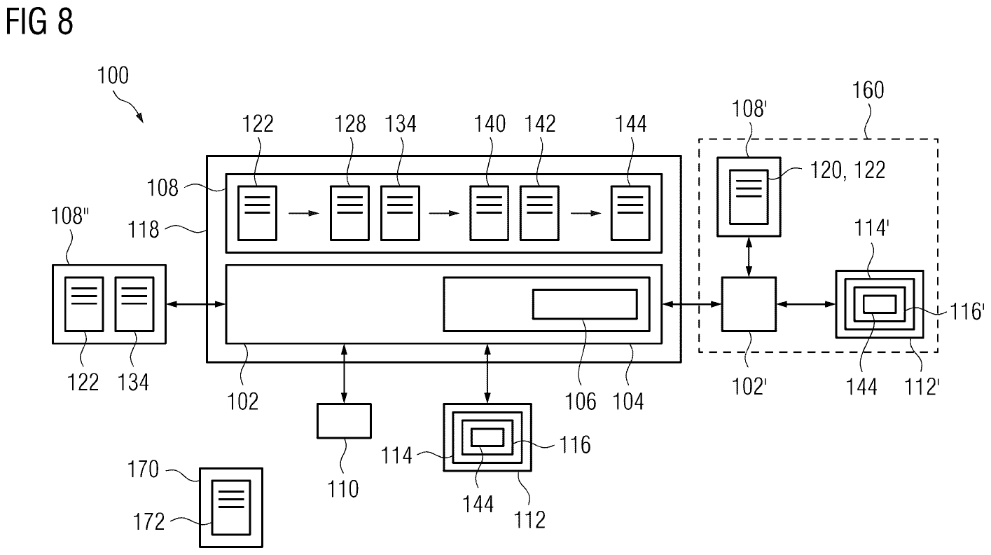

FIG. 8 depicts a functional block diagram of a further example system 100 that facilitates managing an app 120, such as managing an app 120 including an app model 122 and involving a simplified app model 128.

By way of example, the app 120 may be deployed and run on a target device 160 with an internal data store 108′ in which the deployed and operable app 120 may be stored. The target device 160 has a processor 102′ and a display device 112′. The processor 102′ may be configured to generate a target device GUI 114′ through the display device 112′, wherein the GUI 114′ may include a target device operation UI provided to a user of the target device 160. The developed and deployed app 120 may, e.g., have an app UI 116′ which may, e.g., be displayed to the user of the target device 160 via the target device operation UI. In some examples, the target device 160 may include a corresponding UI 116′ capable of outputting information of the app 120, such as the processed data 144, optically, haptically or audibly.

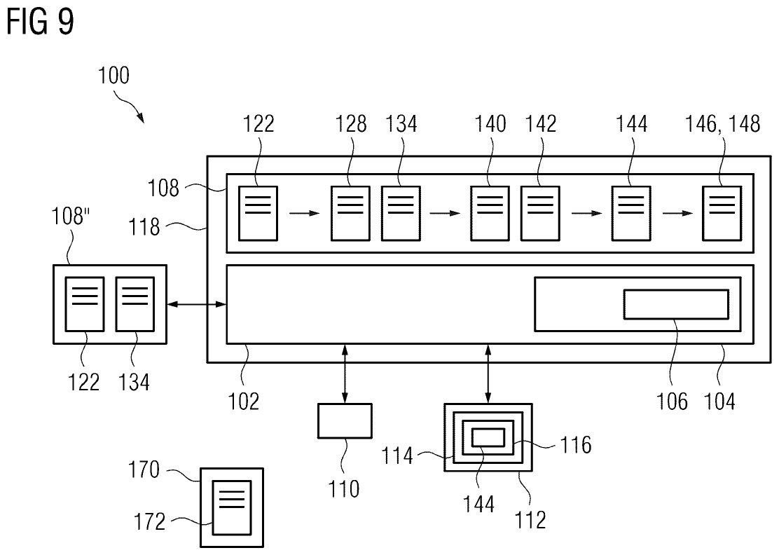

FIG. 9 depicts a functional block diagram of another example system 100 that facilitates managing an app 120, such as managing an app 120 including an app model 122 and involving a simplified app model 128.

The processing type 138 may include generating test data to test the respective subset 136 or a respective QL query relating to the respective subset 136, wherein the processed data 144 may include test data for testing the respective subset 136 or the respective QL query relating to the respective subset 136. Herein, the QL query may be formatted according to a query language, such as SQL or OQL.

In the case of the test data, test results 146 may be determined using the respective test data and the respective subset 136, wherein in the case of the QL query, query results 148 may be determined using the QL query and the respective subset 136. In some examples, for the determination of the respective query results 148 the received user input 134 and/or the LLM 142 may further be used.

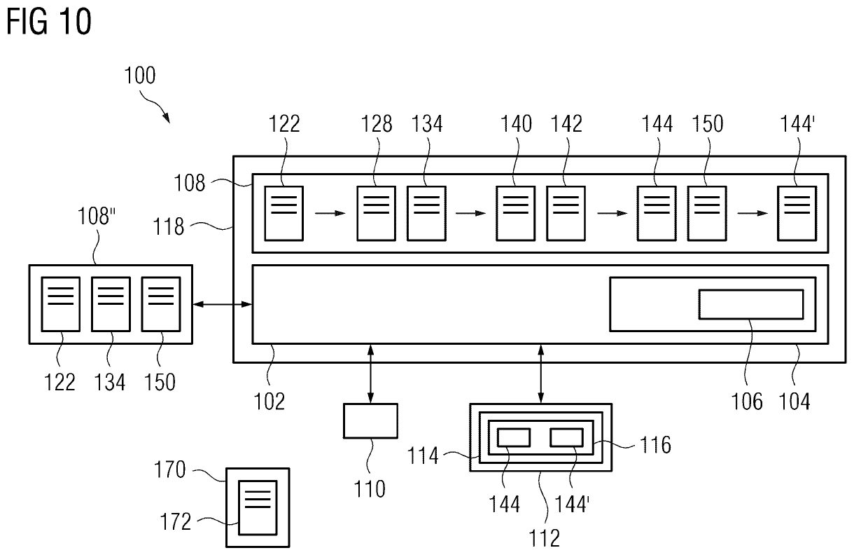

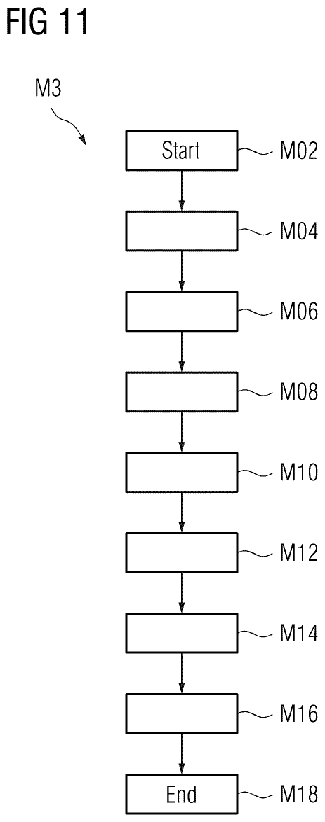

FIG. 10 depicts a functional block diagram of yet another example system 100 that facilitates managing an app 120, such as managing an app 120 including an app model 122 and involving a simplified app model 128.

Further user input 150 may be received via the app management UI 116, wherein the further user input 150 is indicative of an amended query. Then, amended processed data 144′ using the further user input 150. Optionally the amended processed data 144′ may be displayed to the user via the app management UI 116 or to the user of the app 120 the UI of the app 120.

FIG. 11 depicts a flow diagram of a third example methodology M3 that facilitates managing an app, managing an app including an app model and involving a simplified app model in a product system. The app model may include a plurality of entities which are associated with each other, wherein the respective entity includes at least one respective entity attribute. The method may start at M02, and the methodology may include several acts carried out through operation of at least one processor.

These acts may include an act M04 of providing an app management UI of an app management platform to a user for developing the app; an act M06 of providing the app model; an act M08 of determining a simplified app model including a respective first table linking the respective entity with respective entity attribute of the respective entity, and a second table linking the respective entity with the respective, associated entity; an act M10 of receiving natural language user input via the app management UI, wherein the user input is indicative of a query for processing at least one subset of the app model according to a respective processing type, wherein the respective subset includes only some of the entities and some of the entity attributes; an act M12 of determining a respective third table linking two entities, two entity attributes, or one entity and one entity attribute included by the respective subset, respectively, using the user input, the respective first table relating to the entities and the entity attributes of the respective subset, and the second table, and optionally a large language model; an act M14 of determining processed data associated with the respective subset using the processing type, the respective third table, and the large language model; and an act M16 of displaying the processed data. At M18 the methodology may end.

It should further be appreciated that the methodology M3 may include other acts and features discussed previously with respect to the computer-implemented method of managing an app, managing an app including an app model and involving a simplified app model in a product system.

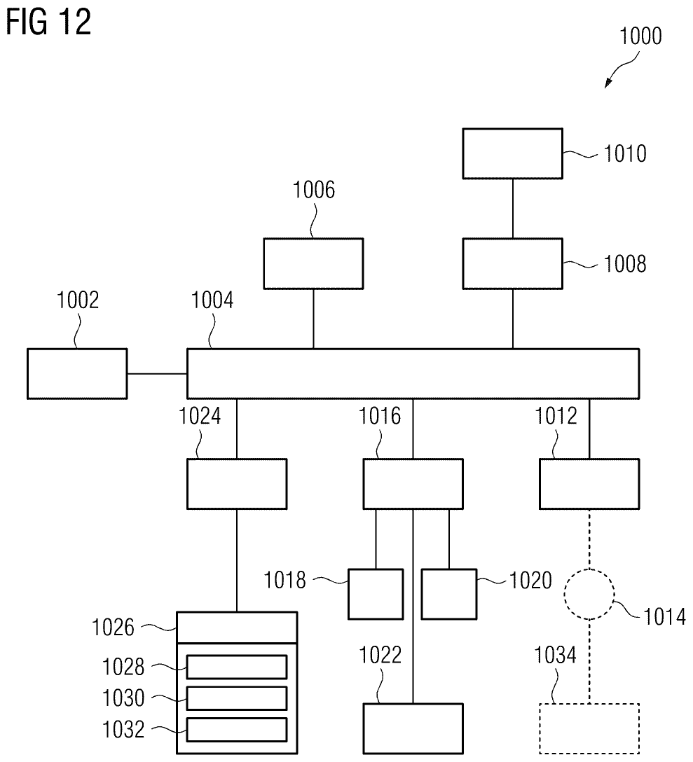

FIG. 12 depicts a block diagram of a data processing system 1000 (also referred to as a computer system) in which an embodiment can be implemented, for example, as a portion of a product system, and/or other system operatively configured by software or otherwise to perform the processes as described herein. The data processing system 1000 may comprise, for example, the computer or IT system or data processing system 100 mentioned above. The data processing system depicted comprises at least one processor 1002 (e.g., a CPU) that may be connected to one or more bridges/controllers/buses 1004 (e.g., a north bridge, a south bridge). One of the buses 1004, for example, may comprise one or more I/O buses such as a PCI Express bus. Also connected to various buses in the depicted example may comprise a main memory 1006 (RAM) and a graphics controller 1008. The graphics controller 1008 may be connected to one or more display devices 1010. It should also be noted that in some embodiments one or more controllers (e.g., graphics, south bridge) may be integrated with the CPU (on the same chip or die). Examples of CPU architectures comprise IA-32, x86-64, and ARM processor architectures.

Other peripherals connected to one or more buses may comprise communication controllers 1012 (Ethernet controllers, WiFi controllers, cellular controllers) operative to connect to a local area network (LAN), Wide Area Network (WAN), a cellular network, and/or other wired or wireless networks 1014 or communication equipment.

Further components connected to various busses may comprise one or more I/O controllers 1016 such as USB controllers, Bluetooth controllers, and/or dedicated audio controllers (connected to speakers and/or microphones). It should also be appreciated that various peripherals may be connected to the I/O controller(s) (via various ports and connections) comprising input devices 1018 (e.g., keyboard, mouse, pointer, touch screen, touch pad, drawing tablet, trackball, buttons, keypad, game controller, gamepad, camera, microphone, scanners, motion sensing devices that capture motion gestures), output devices 1020 (e.g., printers, speakers) or any other type of device that is operative to provide inputs to or receive outputs from the data processing system. Also, it should be appreciated that many devices referred to as input devices or output devices may both provide inputs and receive outputs of communications with the data processing system. For example, the processor 1002 may be integrated into a housing (such as a tablet) that comprises a touch screen that serves as both an input and display device. Further, it should be appreciated that some input devices (such as a laptop) may comprise a plurality of different types of input devices (e.g., touch screen, touch pad, keyboard). Also, it should be appreciated that other peripheral hardware 1022 connected to the I/O controllers 1016 may comprise any type of device, machine, or component that is configured to communicate with a data processing system.

Additional components connected to various busses may comprise one or more storage controllers 1024 (e.g., SATA). A storage controller may be connected to a storage device 1026 such as one or more storage drives and/or any associated removable media, which can be any suitable non-transitory machine usable or machine-readable storage medium. Examples comprise nonvolatile devices, volatile devices, read only devices, writable devices, ROMs, EPROMs, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also, in some examples, a storage device such as an SSD may be connected directly to an I/O bus 1004 such as a PCI Express bus.

A data processing system in accordance with an embodiment of the present disclosure may comprise an operating system 1028, software/firmware 1030, and data stores 1032 (that may be stored on a storage device 1026 and/or the memory 1006). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may comprise Microsoft Windows, Linux, UNIX, iOS, and Android operating systems. Also, examples of data stores comprise data files, data tables, relational database (e.g., Oracle, Microsoft SQL Server), database servers, or any other structure and/or device that is capable of storing data, which is retrievable by a processor.

The communication controllers 1012 may be connected to the network 1014 (not a part of data processing system 1000), which can be any public or private data processing system network or combination of networks, as known to those of skill in the art, comprising the Internet. Data processing system 1000 can communicate over the network 1014 with one or more other data processing systems such as a server 1034 (also not part of the data processing system 1000). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

Further, the term “controller” may be any device, system, or part thereof that controls at least one operation, whether such a device is implemented in hardware, firmware, software, or some combination of at least two of the same. It should be noted that the functionality associated with any particular controller may be centralized or distributed, whether locally or remotely.

In addition, it should be appreciated that data processing systems may be implemented as virtual machines in a virtual machine architecture or cloud environment. For example, the processor 1002 and associated components may correspond to a virtual machine executing in a virtual machine environment of one or more servers. Examples of virtual machine architectures comprise VMware ESCi, Microsoft Hyper-V, Xen, and KVM.

Those of ordinary skill in the art will appreciate that the hardware depicted for the data processing system may vary for particular implementations. For example, the data processing system 1000 in this example may correspond to a computer, workstation, server, PC, notebook computer, tablet, mobile phone, and/or any other type of apparatus/system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

Also, it should be noted that the processor described herein may be located in a server that is remote from the display and input devices described herein. In such an example, the described display device and input device may be comprised in a client device that communicates with the server (and/or a virtual machine executing on the server) through a wired or wireless network (which may comprise the Internet). In some embodiments, such a client device, for example, may execute a remote desktop application or may correspond to a portal device that carries out a remote desktop protocol with the server in order to send inputs from an input device to the server and receive visual information from the server to display through a display device. Examples of such remote desktop protocols comprise Teradici's PCoIP, Microsoft's RDP, and the RFB protocol. In such examples, the processor described herein may correspond to a virtual processor of a virtual machine executing in a physical processor of the server.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, which may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 1000 may conform to any of the various current implementations and practices known in the art.

Also, it should be understood that the words or phrases used herein should be construed broadly, unless expressly limited in some examples. For example, the terms “comprise” and “comprise,” as well as derivatives thereof, provide inclusion without limitation. The singular forms “a”, “an” and “the” are intended to comprise the plural forms as well, unless the context clearly indicates otherwise. Further, the term “and/or” as used herein refers to and encompasses any and all possible combinations of one or more of the associated listed items. The term “or” is inclusive, being and/or, unless the context clearly indicates otherwise. The phrases “associated with” and “associated therewith,” as well as derivatives thereof, may be to comprise, be comprised within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to describe various elements, functions, or acts, these elements, functions, or acts should not be limited by these terms. Rather these numeral adjectives are used to distinguish different elements, functions or acts from each other. For example, a first element, function, or act could be termed a second element, function, or act, and, similarly, a second element, function, or act could be termed a first element, function, or act, without departing from the scope of the present disclosure.

In addition, phrases such as “processor is configured to” carry out one or more functions or processes, may provide that the processor is operatively configured to or operably configured to carry out the functions or processes via software, firmware, and/or wired circuits. For example, a processor that is configured to carry out a function/process may correspond to a processor that is executing the software/firmware, which is programmed to cause the processor to carry out the function/process and/or may correspond to a processor that has the software/firmware in a memory or storage device that is available to be executed by the processor to carry out the function/process. It should also be noted that a processor that is “configured to” carry out one or more functions or processes, may also correspond to a processor circuit particularly fabricated or “wired” to carry out the functions or processes (e.g., an ASIC or FPGA design). Further the phrase “at least one” before an element (e.g., a processor) that is configured to carry out more than one function may correspond to one or more elements (e.g., processors) that each carry out the functions and may also correspond to two or more of the elements (e.g., processors) that respectively carry out different ones of the one or more different functions.

In addition, the term “adjacent to” may provide that an element is relatively near to but not in contact with a further element; or that the element is in contact with the further portion, unless the context clearly indicates otherwise.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present patent document should be read as implying that any particular element, step, act, or function is an essential element, which must be included in the claim scope: the scope of patented subject matter is defined only by the allowed claims.

### Reference Signs List

100 processing system
102 processor
104 memory
106 application software component
108 internal data store
110 input device
112 display device
114 graphical user interface (GUI)
116 app management UI
118 app management platform
120 app
122 app model
124 entity
126 entity attribute
128 simplified app model
130 first table
132 second table
134 user input
136 subset
138 processing type
140 third table
142 large language model
144 processed data
146 test results
148 query results
150 further user input
152 association
154 post processor
160 target device
170 computer-readable medium
172 computer program product

1. A method of managing an app including an app model, wherein the app model includes a plurality of entities that are associated with each other, and wherein a respective entity of the plurality of entities includes at least one respective entity attribute, the method being computer-implemented and comprising:
providing an app management user interface (UI) of an app management platform to a user for managing the app;
providing the app model;
determining a simplified app model including a respective first table linking the respective entity with a respective entity attribute of the respective entity, and a second table linking the respective entity with the respective, associated entity;
receiving user input via the app management UI, wherein the user input is a natural language user input and is indicative of a query for processing at least one subset of the app model according to a respective processing type, wherein the respective subset includes only some of the entities and some of the entity attributes;
determining a respective third table linking two entities, two entity attributes, or one entity and one entity attribute included by the respective subset, respectively, using the user input, the respective first table relating to the entities and the entity attributes of the respective subset, and the second table;
determining processed data associated with the respective subset using the processing type, the respective third table, and a large language model; and
displaying the processed data via the app management UI.

2. The method of claim 1, wherein determining the respective third table further comprises determining the respective third table using the large language model.

3. The method of claim 1, further comprising:
decomposing the respective subset into a plurality of sub-subsets;
determining the respective processed data associated with the respective sub-subset using the processing type, the respective third table, and the respective sub-subset; and
composing the respective processed data associated with the respective subset, the composing comprising joining the respective processed data associated with the respective sub-subset using the respective third table.

4. The method of claim 3, wherein determining the respective processed data associated with the respective sub-subset further comprises determining the respective processed data associated with the respective sub-subset using the large language model.

5. The method of claim 4, wherein the large language model has a context window limiting an input size of the large language model,
wherein the context window is exceeded by the respective subset, or the user input jointly with the respective subset, and
wherein the method further comprises decomposing the respective subset into the plurality of sub-subsets such that the respective sub-subset, or the user input jointly with the respective sub-subset, does not exceed the context window of the large language model.

6. The method of claim 1, wherein the respective processing type includes generating test data to test the respective subset, and
wherein the processed data includes test data for testing the respective subset.

7. The method of claim 6, further comprising:
determining respective test results using the respective test data and the respective subset.

8. The method of claim 7, wherein a number of sets of test data are determined for a number of subsets, and
wherein the method further comprises:
determining composed test results using the respective test data, the second table, and the respective third table; and
determining composed test results using the composed test data and the number of subsets.

9. The method of claim 1, wherein the processing type includes determining at least one workflow for processing the respective entity included by the respective subset or determining at least one page for displaying information derived from respective the entity included by the respective subset via an app UI, and
wherein the processed data includes the respective workflow or the respective page.

10. The method of claim 9, further comprising:
determining a respective updated subset including the determined respective workflow, the determined respective page, or the respective updated subset including the determined respective workflow and the determined respective page; and
determining an updated app model including the respective updated subset.

11. The method of claim 1, wherein the processing type includes determining a respective updated subset including at least one new or updated entity, entity attribute, association between two entities, or any combination thereof, and
wherein the processed data includes the respective updated subset.

12. The method of claim 10, wherein a number of updated subsets are determined, and
wherein the method further comprises:
determining a composed updated app model using the number of updated subsets, the second table, and the respective third table.

13. The method of claim 10, further comprising:
developing the app using the respective updated subset.

14. The method of claim 13, further comprising:
deploying the app on a target device.

15. The method of claim 1, wherein the respective processing type includes generating a respective query relating to the respective subset,
wherein the query is formatted according to a query language, and
wherein the processed data includes the respective query relating to the respective subset.

16. A computer system comprising:
a processor configured to manage an app including an app model, wherein the app model includes a plurality of entities that are associated with each other, and wherein a respective entity of the plurality of entities includes at least one respective entity attribute, the processor being configured to manage the app comprising the processor being configured to:
provide an app management user interface (UI) of an app management platform to a user for managing the app;
provide the app model;
determine a simplified app model including a respective first table linking the respective entity with a respective entity attribute of the respective entity, and a second table linking the respective entity with the respective, associated entity;
receive user input via the app management UI, wherein the user input is a natural language user input and is indicative of a query for processing at least one subset of the app model according to a respective processing type, wherein the respective subset includes only some of the entities and some of the entity attributes;
determine a respective third table linking two entities, two entity attributes, or one entity and one entity attribute included by the respective subset, respectively, using the user input, the respective first table relating to the entities and the entity attributes of the respective subset, and the second table;
determine processed data associated with the respective subset using the processing type, the respective third table, and a large language model; and
display the processed data via the app management UI.

17. A non-transitory computer-readable storage medium that stores instructions executable by one or more processors to manage an app including an app model, wherein the app model includes a plurality of entities that are associated with each other, and wherein a respective entity of the plurality of entities includes at least one respective entity attribute, the instructions comprising:
providing an app management user interface (UI) of an app management platform to a user for managing the app;
providing the app model;
determining a simplified app model including a respective first table linking the respective entity with a respective entity attribute of the respective entity, and a second table linking the respective entity with the respective, associated entity;
receiving user input via the app management UI, wherein the user input is a natural language user input and is indicative of a query for processing at least one subset of the app model according to a respective processing type, wherein the respective subset includes only some of the entities and some of the entity attributes;
determining a respective third table linking two entities, two entity attributes, or one entity and one entity attribute included by the respective subset, respectively, using the user input, the respective first table relating to the entities and the entity attributes of the respective subset, and the second table;
determining processed data associated with the respective subset using the processing type, the respective third table, and a large language model; and
displaying the processed data via the app management UI.
